(19) United States
(12) Patent Application Publication
(10) Pub. No.: US 2024/0011645 A1
(43) Pub. Date: Jan. 11, 2024

(54) MODULAR FLUID HEATING DEVICE, HEATING SYSTEM PROVIDED WITH SUCH A FLUID HEATING DEVICE

(71) Applicant: Reflexy Nederland B.V., Winkel (NL)

(72) Inventor: Leonardus Gijsbertus Theodorus Moerings, Winkel (NL)

(21) Appl. No.: 18/039,768

(22) PCT Filed: Dec. 2, 2021
(86) PCT No.: PCT/IB2021/000871

§ 371 Date: Jun. 1, 2023

(30) Foreign Application Priority Data
Dec. 4, 2020 (NL) 2027045

(51) Int. Cl. F24D 3/02; F24H 1/10; F24H 9/00; H05B 3/00

(52) U.S. Cl. CPC F24D 3/02; F24H 1/101; F24H 9/0015; H05B 3/0052; F24H 2250/14

(57) ABSTRACT

A modular fluid heating device for a heating system having a fluid circuit includes a supply conduit and a discharge conduit, which are connectable to a return side and a feeding side of the fluid circuit of the heating system, and having at least one fluid heating module which is connectable to the supply conduit and the discharge conduit. A sleeve is arranged concentrically within the fluid tube, which sleeve extends at least into the necks of the fluid tube. A threaded ring is configured to cooperate with a thread of the neck, and engages a sealing ring so as to seal the ends of the fluid tube. The fluid tube has, spaced apart from the respective necks, an inlet or and outlet, respectively, which can be coupled directly with the discharge conduit or supply conduit, respectively. The fluid heating module further includes an infrared lamp.

### CROSS-REFERENCE TO RELATED APPLICATIONS

This application is the National Stage of International Application No. PCT/IB2021/000871, filed Dec. 2, 2021, which claims the benefit of Netherlands Application No. 2027045, filed Dec. 4, 2020, the contents of which is incorporated by reference herein.

### FIELD OF THE INVENTION

The invention relates to the electrical heating of fluids.

### SUMMARY OF THE INVENTION

In particular, the invention relates to a modular fluid heating device for a heating system with a fluid circuit, wherein the fluid heating device comprises a supply conduit and a discharge conduit, which are connectable to a return side and a feeding side of the fluid circuit of the heating system, and having at least one fluid heating module which is connectable to the supply conduit and the discharge conduit,
wherein the fluid heating module comprises a substantially straight fluid tube having a threaded neck formed on each end thereof, a sleeve that is arranged concentrically within the fluid tube, which sleeve extends at least into the necks of the fluid tube, wherein in each neck a sealing ring is arranged between the neck and the sleeve, and a threaded ring is configured to cooperate with the thread of the neck, and which engages the sealing ring so as to seal the ends of the fluid tube, and wherein the fluid tube has, spaced apart from the respective necks, an inlet or and outlet, respectively, which can be coupled directly with the discharge conduit or supply conduit, respectively,
wherein the fluid heating module further comprises an infrared lamp having end consoles that rest on end portions of the sleeve, wherein electrical connection wires protrude from one or both end consoles so as to connect the infrared lamp to a power source.

The fluid heating device according to the invention has the advantage that it is a simple fluid heating device which can be used in many fluid heating applications. A practical example of an application is central heating (central heating) in homes or other buildings by means of radiators or floor or wall heating, hot water supplies. The advantages of the device will be explained below on the basis of this practical example. However, it is expressly pointed out that the fluid heating device according to the invention can also be used in many other domestic, professional or industrial applications, with often the same advantages as in a central heating system. The fluid heating device can for instance also be used in (professional) kitchen equipment, bakeries, breweries, (industrial) distillation installations, etc.

The device only works on electric current, which makes a gas connection and a flue gas outlet superfluous in the case of a central heating system, for example. Moreover, with the use of the infrared lamps, the heating of the fluid to be heated can take place very efficiently and quickly.

The modular character of the fluid heating device makes it possible to easily match the heating capacity of the device to the required heating capacity in the heating system. For instance, the number of modules that are placed in the fluid heating device in a central heating system can be matched to the number of radiators present in the central heating system. In other words, the capacity can be easily adjusted to the specific heat demand required at a particular application location. Furthermore, the modular character makes it easy to expand or possibly scale down that capacity.

Another advantage of the device according to the invention is that it requires little maintenance. Where, for example, with a gas-fired central heating boiler you have to perform annual maintenance mainly on the gas burner, this is not necessary with the fluid heating device according to the invention. When the life of the infrared lamp of one of the fluid heating modules has expired, the respective fluid heating module can be easily replaced without too much specialist knowledge.

In a possible embodiment, the supply conduit and the discharge conduit each have a connection portion, the connection portions extending parallel to one another and being provided with connection points for connecting one or more fluid heating modules, wherein the connection points in the supply conduit and in the discharge conduit corresponding to one fluid heating module are substantially at the same height.

In a further embodiment, the connection points of the supply conduit and the discharge conduit comprise connectors to couple the inlet and outlet of the fluid tube of the fluid heating module with the supply and discharge conduits. The connectors facilitate the easy installation and removal of the modules on the supply and discharge conduits.

In a further embodiment, wherein the connection points comprise an operable valve to close off the respective connection point when the connection point is not in use or a fluid heating module is to be connected or disconnected, and to open the connection point when a fluid heating module is coupled thereto. It is envisaged that the infrared lamps in the system will not be replaced individually when the service life has expired, but that the entire module of which the lamp in question forms part will be replaced. The said operable valve in the connection points makes it very easy to connect or disconnect modules without having to empty the entire system (for example central heating system) of which the fluid heating device forms part.

This specific embodiment of the device can be used in a method for replacing a fluid heating module of the device, wherein the fluid heating module is disconnected from the supply conduit and discharge conduit, whilst the system is still filled with fluid to be heated, and wherein a replacement fluid heating module is connected to the supply conduit and discharge conduit, and wherein fluid to be heated is possibly supplemented to the system.

In a somewhat simpler and cheaper embodiment, it is possible to provide the supply conduit upstream of the connection points and the discharge conduit downstream of the connection points with main valves with which the connection sections of the supply conduit and the discharge conduit can be closed. A vent and/or a tapping point being provided in at least one of the supply and discharge conduits allows to release pressure and fluid from the modules and the connection portions of the supply and discharge conduit. This makes the use of operable valves in the connection points unnecessary, and modules can be exchanged while only the fluid heating device between the main valves is closed and drained.

This specific embodiment of the device can be used in a method of replacing a fluid heating module of the device, wherein:
the main valves in the supply and discharge conduits are closed;
the vent and/or drain is opened to release pressure and/or to drain fluid;
the fluid heating module is disconnected from the supply conduit and discharge conduit;
a replacement fluid heating module is connected to the supply conduit and discharge conduit; and
fluid to be heated is possibly supplemented to the system.

In a possible embodiment, the fluid tube has an axis, and wherein the inlet and outlet of the fluid tube have parallel axes perpendicular to the axis of the fluid tube.

In a possible embodiment, the fluid tube is made of metal, preferably of stainless steel.

In a possible embodiment, a fixing ring is included in the threaded ring for (axially) fixing of the infrared lamp in the sleeve. The fixing ring ensures that the infrared lamp cannot be removed from the sleeve without removing the threaded ring or the fixing ring. As described above, it is not preferred to remove the infrared lamps from the module when the module is incorporated into the fluid heating device.

In a possible embodiment, the fluid heating module is embedded in a silicone casing, wherein only the connection wires of the infrared lamp protrude from the casing. The silicone casing primarily provides thermal insulation which increases the efficiency of the device. Furthermore, the silicone casing can serve as a “security feature” that makes it difficult to remove the infrared lamp from the module, and as a “tamper-evident” feature showing that an end user has removed the infrared lamp.

In a possible embodiment, flow obstacles are arranged in the fluid tube around the sleeve to induce directional changes in the fluid flow through the fluid heating module. The flow obstacles increase the residence time of the flowing fluid through the module and thus enable better heat absorption by the fluid.

In a further embodiment, the flow obstacles are formed by round balls located in the space between the sleeve and the interior of the fluid tube. These balls may advantageously be spherical magnets. Spherical magnets attract each other and ensure a tight and regular positioning of the balls around the sleeve.

In a possible embodiment, the threads on the necks are an outer thread provided on the outside of the neck and the threaded ring is an inner threaded union nut.

In another possible embodiment, the threads on the necks are internal threads provided on the inside of the neck and the threaded ring is an externally threaded ring.

The sealing ring used is in a practical embodiment a silicone sealing ring, but could also be a sealing ring of another suitable material.

The sealing ring is preferably configured to prevent the metallic contact between the threaded ring and the sleeve. This avoids direct heat transfer between the sleeve and the threaded ring, so that the sleeve is forced to give off more heat to the surrounding fluid, which improves the efficiency of the device.

In a possible embodiment, the fluid tube has a non-circular, preferably a substantially square cross-section in the portion between the necks. This shape has the advantage that the modules can be placed relatively close to each other and the length area of the supply conduit and discharge conduit where the connections are located can therefore be shorter. This configuration results in a more compact heating device. However, it is also possible in another embodiment for the fluid tube to have a round, preferably a substantially circular cross-section in the part between the necks.

The invention further relates to a heating system having a fluid circuit and a circulation pump included in the fluid circuit, and further comprising a fluid heating device as described above included in the circuit, as well as at least one heat emission device in the circuit. The heat emission device can for instance be a radiator, a wall or floor heating device. The system may comprise several types of heat emission devices, so for instance a number of radiators and a floor heating device, or a number of radiators and a heat exchanger.

The heat emission device can therefore also comprise a heat exchanger. For example, it is possible to have the fluid heated by the fluid heating device flow through a heat exchanger in order to heat up another medium, for instance water for a hot water pipe, or frying oil for a deep-fat fryer. With one or more heat exchangers, for example, a combination system can be set up for heating central heating water and hot (drinking) water. With a three-way valve it is then possible to switch in a known manner between heating hot water and heating central heating water.

In a further embodiment, the heating system comprises a controller for controlling the heating power delivered by the infrared lamp of the at least one fluid heating module.

In a possible embodiment, the controller comprises a thermostat and a separate solid state relay (SSR) for each fluid heating module, the solid state relay being coupled to the thermostat to receive an input signal therefrom and being coupled to the infrared lamp to control the voltage determined by the input signal to the infrared lamp. This controller is simple and robust and results in a relatively inexpensive solution.

In a further embodiment, the controller includes a solid state relay (SSR) for the circulation pump.

The thermostat preferably comprises a simple PI control. The thermostat can modulate the power output of the IR lamps via the SSRs.

It is also possible to use more advanced controllers, which can be programmed, for example. A controller can be used that can control modulating and/or pulsating to control the power of the IR lamps via SSRs.

The invention further relates to a method of assembling a fluid heating device as described above. The method comprising the following steps:
calculating the required heating power and determining therefrom the required number of fluid heating modules;
providing the required number of modules;
providing a supply conduit and discharge conduit having sufficient connection points to be able to couple the required number of fluid heating modules to the supply conduit and the discharge conduit;
coupling the fluid heating modules to the supply conduit and the discharge conduit.

A further aspect of the invention relates to fluid heating and fluid cooling in one device. To this end, the modular fluid heating device described above can be extended with at least one fluid cooling module, which is connected to the same supply conduit and discharge conduit as the at least one fluid heating module. In this way, the device can selectively heat fluid or cool fluid.

The fluid cooling module comprises a substantially straight fluid tube having a threaded neck formed on each end thereof, a sleeve that is arranged concentrically within the fluid tube, which sleeve extends at least into the necks of the fluid tube, wherein in each neck a sealing ring is arranged between the neck and the sleeve, and a threaded ring is configured to cooperate with the thread of the neck, and which engages the sealing ring so as to seal the ends of the fluid tube, and wherein the fluid tube has, spaced apart from the respective necks, an inlet or and outlet, respectively, which can be coupled directly with the discharge conduit or supply conduit, respectively. The fluid cooling module further has a gas connection at one end which is connected to the internal space of the sleeve and which is connectable to a cooling gas source, preferably a CO₂ gas source, and has a condensate discharge at an opposite end.

The cooling gas source may be, for example, a gas bottle or gas cylinder filled with CO₂ gas, which is an easily obtainable commercial product.

A gas atomiser is preferably arranged between the gas connection and the internal space of the sleeve to atomise the CO₂ gas and to form dry ice in said internal space of the sleeve.

The gas in the gas source, for example the CO₂ gas bottle or cylinder, has a high pressure. Preferably, a reducing valve is provided between the cooling gas source and the fluid cooling module to reduce the gas pressure before it enters the cooling module.

According to this aspect, the invention also relates to a heating-cooling system having a fluid circuit and a circulation pump included in the fluid circuit, and further comprising a fluid heating/cooling device as described above that is included in the circuit, as well as at least one heat emission/heat absorption device in the circuit.

The at least one heat emission/heat absorption device is preferably at least of the radiator, wall heating/cooling device, floor heating/cooling device or heat exchanger type. For example, it is possible to heat and cool a room with a (panel) radiator, depending on the temperature of the fluid that flows through the fluid circuit. By switching on the fluid heating modules or fluid cooling modules as required, it is possible to heat or cool the space.

The system may comprise a plurality of heat emission/heat absorption devices, which are of the same type, or a combination of different types.

The fluid cooling modules are similar to the fluid heating modules. They preferably use the same fluid tube and preferably also the same sleeve. Only the connections on the ends need to be modified to make them suitable to provide a gas connection for a gas source and a condensate drain for condensation formed.

The invention is further elucidated in the description below with reference to the drawings.

### BRIEF DESCRIPTION OF THE DRAWINGS

FIG. 1 shows a perspective view of a fluid heating module according to the invention.

FIG. 2 shows a perspective view of an embodiment of a modular fluid heating device according to the invention.

FIG. 3 shows a front view of the fluid heating device of FIG. 2.

FIG. 4 shows a top view of the fluid heating device of FIG. 2.

FIG. 5 shows a longitudinal section of the module of FIG. 1.

FIG. 6 schematically shows an embodiment of an electronic control of infrared lamps in a fluid heating device of the type shown in FIG. 2.

FIG. 7 shows a front view of the fluid heating and fluid cooling device according to the invention.

FIG. 8 is a view of the fluid heating and fluid cooling device of FIG. 7 along the conduit VII-VII in FIG. 7.

### DETAILED DESCRIPTION OF THE INVENTION

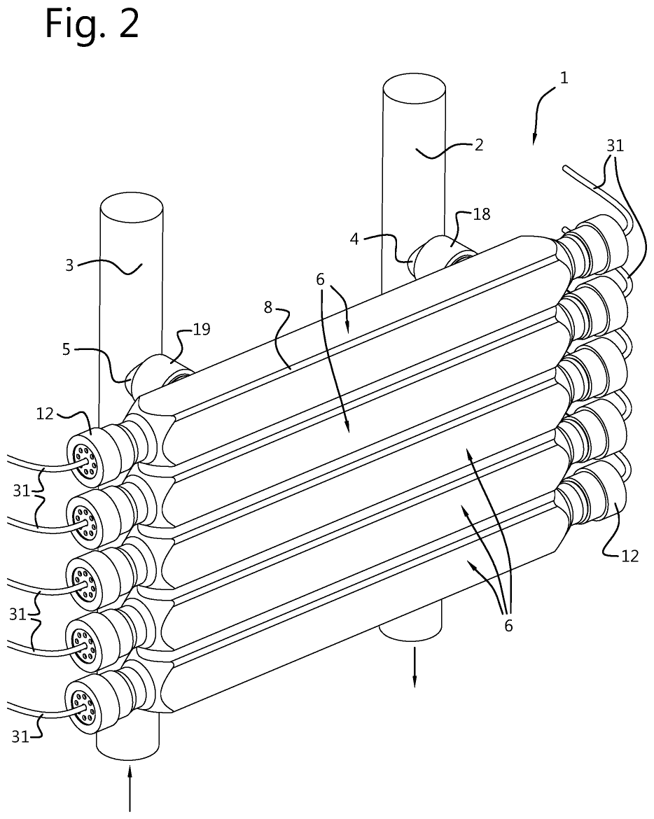

In FIG. 2-4, a fluid heating device 1 according to the invention is shown, which in particular is suitable for use in a central heating system.

The fluid heating device 1 comprises a supply conduit 2 and a discharge conduit 3. The supply conduit 2 is connected to a return conduit of the heating system (e.g. central heating system). The discharge conduit 3 is connected to a supply conduit of the heating system. For example, in a central heating system, the supply conduit carries the heated fluid to the radiators or other heat emission devices, the return conduit returns the fluid cooled by the radiators back to the fluid heating device 1.

The supply conduit 2 and discharge conduit 3 have a connection portion where they extend parallel to each other and each has a number of connection points 4 and 4, respectively. The associated connection points 4, 5 on the supply conduit 2 and the discharge conduit 3 are at the same height.

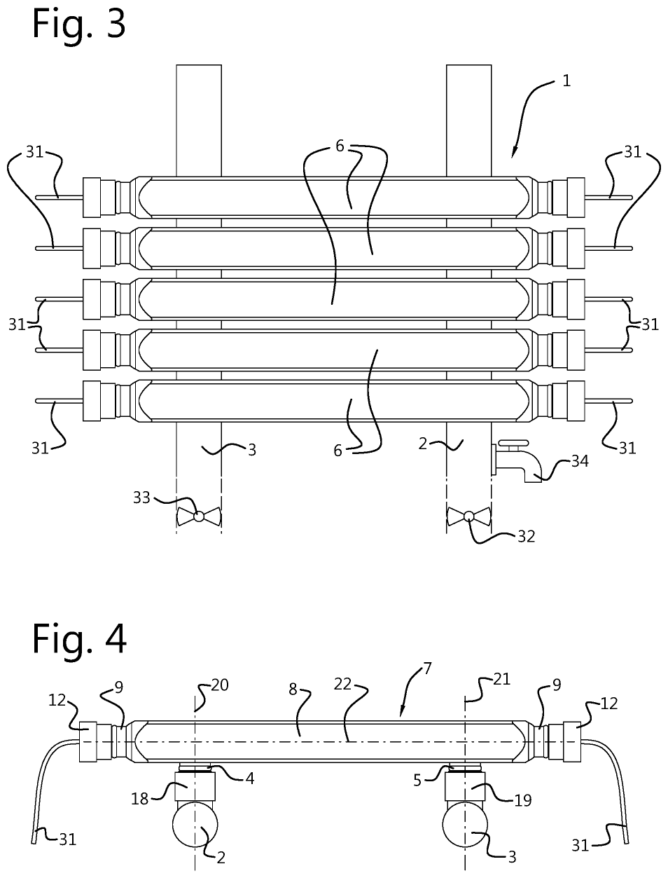

Fluid heating modules 6 are connected to connection points 4, 5. In FIGS. 2 and 3 it can be seen that the device in this case has five fluid heating modules 6. The connection points 4, 5 of the supply and discharge conduit comprise connectors 18, 19 for coupling an inlet 13 and an outlet 14 of the fluid tube 7 of the fluid heating module 6 to the supply conduit 2 and discharge conduit 3.

In a possible embodiment, not shown here, the connection points 4, 5 can have an operable valve to close off the relevant connection point 4, 5 when the connection point 4, 5 is not in use or a fluid heating module 6 has to be connected or disconnected. The valve releases the connection point 4, 5 when a fluid heating module 6 is connected to it. In this way, the fluid heating module 6 can be disconnected from the supply conduit 2 and discharge conduit 3, while the system is still filled with fluid to be heated. Advantageously, a replacement fluid heating module 6 can thus be connected to the supply conduit 2 and discharge conduit 3, after which fluid to be heated is possibly supplemented in the system.

In another embodiment schematically illustrated in FIG. 3, the supply conduit 2 and the discharge conduit 3 can be closed with respective main valves 32 and 33. On one of the conduits 2 and 3, in the example of FIG. 3, a drain valve 34 is provided, with which fluid can be drained from the fluid heating device 1, in order to subsequently be able to replace, remove or additionally place fluid heating modules 6.

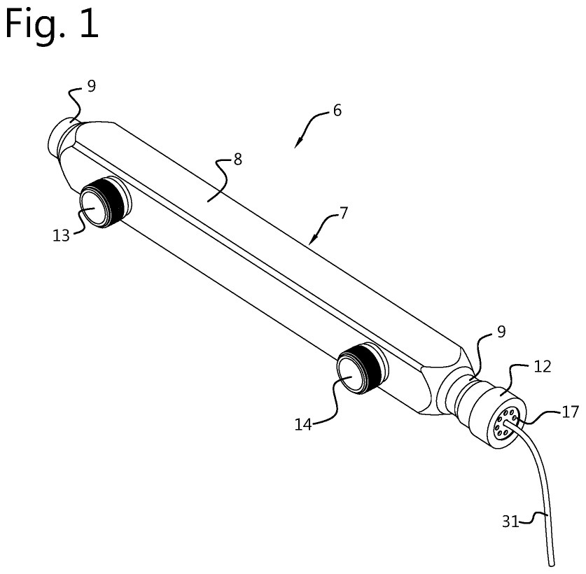

In FIG. 1, a separate fluid heating module 6 is shown. The fluid heating module 6 comprises a substantially straight fluid tube 7 having a neck 9 formed on each end. The fluid tube 7 has a substantially square cross-section in the part 8 situated between the necks 9. The fluid tube is preferably made of stainless steel (stainless steel), but could also be made of another suitable metal.

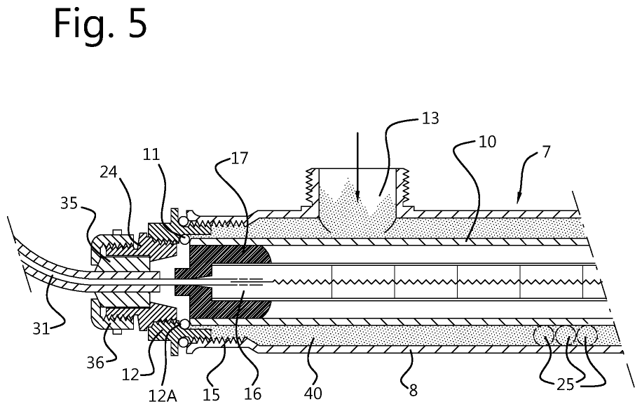

In FIG. 5, a partial section is shown to illustrate the internal construction of the module 6. Arranged in the fluid tube 7 is a sleeve 10 which extends at least into the necks 9 of the fluid tube 7. The sleeve 10 can also be made of stainless steel. A threaded ring 12 is arranged to cooperate with internal thread 15 of the neck 9. Between the end face of the sleeve 10 and a shoulder 12A formed in the threaded ring 12, a sealing ring 11 is arranged to seal the ends of the fluid tube 7. Furthermore, the sealing ring 11 ensures that there is no direct metallic contact between the threaded ring 12 and the sleeve 10, thereby preventing the threaded ring 12 and the neck 9 of the fluid tube from becoming too hot. Moreover, in this way no heat is lost via the threaded ring 12 and the neck 9 of the fluid tube 7, which can otherwise be emitted to the fluid 40. The sealing ring 11 is made, for example, of silicone rubber.

The fluid tube 7 has, spaced apart from the respective necks 9, the inlet 13 and the outlet 14, respectively, which can be directly coupled at the connection points to the discharge conduit 3 and the supply conduit 2. The inlet 13 and outlet 14 of the fluid tube 7 have parallel axes 20, 21 which are perpendicular to the axis 22 of the fluid tube 7 as indicated in FIG. 4.

The fluid heating module 6 comprises an infrared lamp 16. The infrared lamp 16 is in particular a short wave quartz infrared lamp. The infrared lamp 16 has end consoles 17 which rest on end portions of the sleeve 10. The end consoles 17 are of ceramic material. Electrical connection wires 31 extend from both of the end consoles 17 to connect the infrared lamp 16 to a power source.

A fixing ring 24 is received in the threaded ring 12 for axially fixing the infrared lamp 16 in the sleeve 10. In the fixing ring 24 there is a plug 35 which in turn is fixed with a ring nut 36 which is screwed onto an outer threaded portion of the fixing ring 24.

It is noted that the shown embodiment of the neck 9 and the elements being 12, 24, 35, 36 arranged thereon is only an example of a practical embodiment. It is, for example, also possible to provide external threads on the outside of the neck 9 instead of internal threads. The threaded ring then has, for example, the form of a ring nut with an internally threaded portion which is screwed onto the threaded end of the neck 9.

The fluid heating module 6 can be embedded in a silicone casing, wherein only the connecting wires 31 of the infrared lamp 16 protrude from the casing. The silicone casing provides heat insulation and prevents an end user from unscrewing the threaded rings 12 too easily. The silicone casing can be applied by placing the fluid heating module in a mould and then filling the mould with liquid silicone rubber which can then be cured.

In a possible embodiment, round balls can be arranged in the space between the sleeve and the inside of the fluid tube. These balls are preferably spherical magnets which become tight against each other as they surround the sleeve 10. In FIG. 5, three balls 25 are shown in dotted conduits at the bottom right of the figure, by way of example. When balls 25 are used in an embodiment, the space between the sleeve 10 and the fluid tube is filled as much as possible. The balls 25 form a flow barrier to the fluid flow which moves from the inlet 13 through the space defined by the portion 8 of the fluid tube 7 and the sleeve 10 to the outlet 14. The fluid is thus forced to change direction and remains longer in the tube 7 and is thus heated up more effectively by the IR lamp 16. The occurrence of vortices in the flow can help to make the heating more effective.

In practice, the fluid heating device 1 can be assembled on site, i.e. for instance in the house to be heated.

The required heating power can be calculated in advance and the required number of fluid heating modules 6 can be determined therefrom. The required number of modules 6 can then be brought to the house together with a supply conduit and discharge conduit with sufficient connection points to enable coupling of the required number of fluid heating modules. The supply pipe and the discharge pipe are connected to the supply and return pipes of a central heating system of the home. Then the fluid heating modules are coupled to the supply conduit and the discharge conduit. It is also possible to first connect the modules to the supply and discharge pipes and then connect the latter to the supply and return pipes of the central heating system.

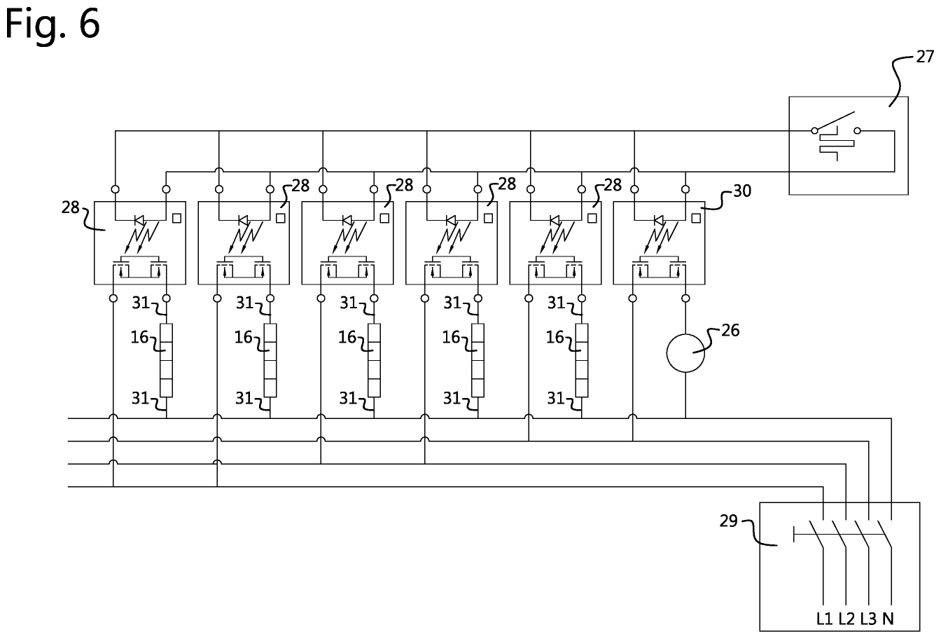

In FIG. 6 is shown a schematic representation of the control system for controlling the IR lamps 16 in a heating system having a fluid circuit and a circulation pump included the fluid circuit, and further comprising a heating device as described above included in the fluid circuit. The heating system comprises at least one heat emission device in the circuit, such as for instance a radiator.

In the scheme of FIG. 6 the five IR lamps 16 can be seen. The pump is indicated by reference numeral 26. The IR lamps 16 have, for example, a power of 1.8 kW. An advantage of a short wave quartz infrared lamp 16 is that it can heat up to 400° C. in 2 seconds. As a result, the fluid heating device can very quickly heat up fluid when there is a need for it.

The control includes a thermostat 27 as well as five solid state relays 28, each is associated with one of the fluid heating modules, and in particular its IR lamp 16. Each solid state relay 28 is coupled to the thermostat 27 to receive an input signal therefrom and is coupled to its corresponding infrared lamp 16 to send the voltage determined by the input signal to the infrared lamp 16. In practice, for example, the thermostat may include a PI control with an output signal of 0-10V DC. The solid-state relays 28 are supplied with an alternating voltage of 230V and convert the input signal to an alternating voltage in the range 0-230V with which the IR lamps 16 are controlled. The system also has a main switch 29, in the case shown for three-phase connection. The pump 26 is coupled to its own solid-state relay 30 that switches between 0 and 230V AC to turn the pump 26 on and off.

The control described is very easy to achieve with a simple commercially available modulating room thermostat and with simple commercially available solid-state relays (SSRs). This provides a simple and inexpensive, yet robust solution. It is of course also possible to use more advanced and programmable controllers to control a fluid heating device according to the invention.

The heating device 1 as shown in FIGS. 2-4 can in particular also be used in a combination system, in which there is a heating circuit for the central heating system, i.e. for heating spaces, and a heating circuit for heating warm (drinking) water. The combination system has a 3-way valve that can switch the system from central heating to heating hot water, and wherein one or more heat exchangers are present to exchange heat between the heating water (central heating water). and the drinking water to be heated.

It should be understood that the above-described central heating system only serves to illustrate a possible practical application of the fluid heating device according to the invention. Due to the extensive applicability, scalability, simplicity and wide temperature range of the modular fluid heating device according to the invention, it is also valuable in both domestic, professional and industrial applications.

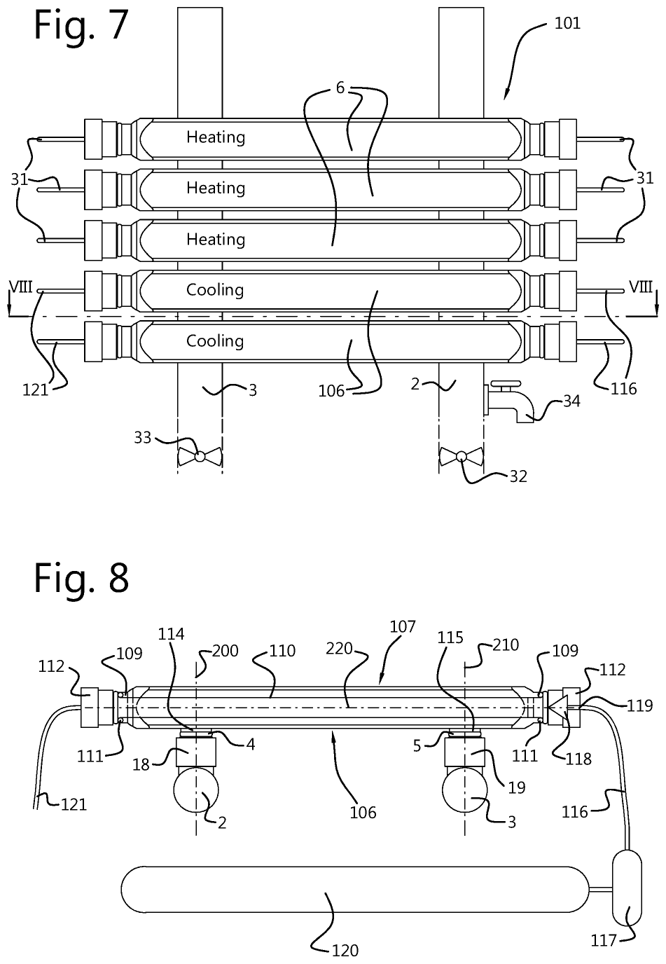

FIG. 7 and FIG. 8 illustrate a further aspect of the invention, i.e. a fluid heating and fluid cooling in one system. FIG. 7 schematically shows a modular fluid heating and fluid cooling device 101.

The fluid heating and cooling device, as in the above-described fluid heating device, is provided with modules, which may be fluid heating modules 6 or fluid cooling modules 106. The fluid heating modules 6 are the same as the fluid heating modules 6 described above. The fluid cooling module 106 is connected to the supply conduit 2 and discharge conduit 3 in the same manner as the fluid heating module 6.

The fluid cooling module 106 comprises a substantially straight fluid tube 107 having a threaded neck 109 formed on each end thereof. A sleeve 110 is arranged concentrically within the fluid tube 107, which sleeve 110 extends at least into the necks 109 of the fluid tube 107. In each neck 109 a sealing ring is arranged between the neck 109 and the sleeve 110, and a threaded ring 112 is configured to cooperate with the thread of the neck 209, and which engages the sealing ring 111 so as to seal the ends of the fluid tube 107.

The fluid tube 107 has, spaced apart from the respective necks 109, an inlet 115 or an outlet 114, respectively, which can be coupled directly with the discharge conduit 3 or supply conduit 2, respectively. The inlet 115 and outlet 114 of the fluid tube 107 have parallel axes 200, 210 that are perpendicular to the axis 220 of the fluid tube 107 as is indicated in FIG. 8.

The fluid cooling module 106 further has a gas connection 119 at one end which is connected to the internal space of the sleeve 110 and which is connectable to a cooling gas source 120, preferably a CO₂ gas source, and has a condensate discharge 121 at an opposite end.

The cooling gas source 120 may be, for example, a gas bottle or gas cylinder filled with CO₂ gas, which is an easily obtainable commercial product.

Preferably, a gas atomiser 118 is arranged between the gas connection 119 and the internal space of the sleeve 110 to atomise the CO₂ gas and form dry ice in said internal space of the sleeve 110.

The gas in the gas source 120, for example the CO₂ gas bottle or cylinder, is at a high pressure. Preferably, a reducing valve 117 is provided between the cooling gas source 120 and the fluid cooling module to reduce the gas pressure before it enters the cooling module 106. In the case of a gas cylinder or gas bottle, the reducing valve 117 may be fitted to the gas bottle or cylinder. A gas hose 116 or other gas line is arranged between the reducing valve 117 and the connection 119.

A heating-cooling system may be configured like the heating system described above, i.e. having a fluid circuit and a circulation pump included in the fluid circuit. The system further comprises at least one heat emission/heat absorption device in the circuit for releasing heat into a space (heating) or for absorbing heat (cooling). This may be the same element. For example, it is possible to use a radiator to give off heat or to absorb heat. Other heat exchangers may also be used. The system further includes a circulating fluid heating/cooling device as described above.

By switching on the fluid heating modules 6 or fluid cooling modules 106, depending on the need, it is possible to heat or cool the space. This takes place by means of a control system which, at least for the heating modules 6, may be configured as shown in FIG. 6. For the cooling modules 106, a control component is then used to actuate a gas valve with which the cooling gas supply to the cooling module 106 is controlled.

The fluid cooling modules 106 are similar to the fluid heating modules 6. They preferably use the same fluid tube and preferably also the same sleeve. Only the connections on the ends have to be adapted to make them suitable for providing a gas connection for a gas source 120 and a condensate discharge for condensation formed.

1. A modular fluid heating device for a heating system having a fluid circuit, wherein the fluid heating device comprises a supply conduit and a discharge conduit, which are connectable to a return side and a feeding side of the fluid circuit of the heating system, and having at least one fluid heating module which is connectable to the supply conduit and the discharge conduit,
wherein the fluid heating module comprises a substantially straight fluid tube having a threaded neck formed on each end thereof, a sleeve that is arranged concentrically within the fluid tube, which sleeve extends at least into the necks of the fluid tube, wherein in each neck a sealing ring is arranged between the neck and the sleeve, and a threaded ring is configured to cooperate with the thread of the neck, and which engages the sealing ring so as to seal the ends of the fluid tube, and wherein the fluid tube has, spaced apart from the respective necks, an inlet or and outlet, respectively, which can be coupled directly with the discharge conduit or supply conduit, respectively,
wherein the fluid heating module further comprises an infrared lamp having end consoles that rest on end portions of the sleeve, wherein electrical connection wires protrude from one or both end consoles so as to connect the infrared lamp to a power source.

2. The modular fluid heating device according to claim 1, wherein the supply conduit and the discharge conduit each have a connection portion, the connection portions extending parallel to one another and being provided with connection points for connecting one or more fluid heating modules, wherein the connection points in the supply conduit and in the discharge conduit corresponding to one fluid heating module are substantially at the same height.

3. The modular fluid heating device according to claim 2, wherein the connection points of the supply conduit and the discharge conduit comprise connectors to couple the inlet and outlet of the fluid tube of the fluid heating module with the supply and discharge conduits.

4. The modular fluid heating device according to claim 3, wherein the connection points comprise an operable valve to close off the respective connection point when the connection point is not in use or a fluid heating module is to be connected or disconnected, and to open the connection point when a fluid heating module is coupled thereto.

5. The modular fluid heating device according to claim 3, wherein the supply conduit upstream of the connection points and the discharge conduit downstream of the connection points are provided with main valves with which the connection sections of the supply conduit and the discharge conduit can be closed, and wherein a vent and/or a tapping point is provided in at least one of the supply and discharge conduits to release pressure and fluid from the modules and the connection portions of the supply and discharge conduit respectively when the main valves are closed.

6. The modular fluid heating device according to claim 1, wherein the fluid tube has an axis, and wherein the inlet and outlet of the fluid tube have parallel axes perpendicular to the axis of the fluid tube.

7. The modular fluid heating device according to claim 1, wherein the fluid tube is made of metal, preferably of stainless steel.

8. The modular fluid heating device according to claim 1, wherein a fixing ring is included in the threaded ring for (axially) fixing of the infrared lamp in the sleeve.

9. The modular fluid heating device according to claim 1, wherein the fluid heating module is embedded in a silicone casing, wherein only the connection wires of the infrared lamp protrude from the casing.

10. The modular fluid heating device according to claim 1, wherein flow obstacles are arranged in the fluid tube around the sleeve to induce directional changes in the fluid flow through the fluid heating module.

11. The modular fluid heating device according to claim 10, wherein the flow obstacles are formed by round balls located in the space between the sleeve and the interior of the fluid tube.

12. The modular fluid heating device according to claim 11, wherein the balls are spherical magnets.

13. The modular fluid heating device according to claim 1, wherein the threads on the necks are an outer thread provided on the outside of the neck and the threaded ring is an inner threaded ring nut.

14. The modular fluid heating device according to claim 1, wherein the threads on the necks are internal threads provided on the inside of the neck and the threaded ring is an externally threaded ring.

15. The modular fluid heating device according to claim 1, wherein the sealing ring is a silicone sealing ring.

16. The modular fluid heating device according to claim 1, wherein the fluid tube has a non-circular, preferably a substantially square cross-section in the portion between the necks.

17. The modular fluid heating device according to claim 1, wherein the fluid tube has a round, preferably a substantially circular cross-section in the portion between the necks.

18. A heating system having a fluid circuit and a circulation pump included in the fluid circuit, and further comprising a fluid heating device according to claim 1 included in the circuit, as well as at least one heat emission device in the circuit.

19. The heating system according to claim 18, wherein the at least one heat emission device is at least of the radiator, wall heating device, floor heating device or heat exchanger type.

20. The heating system according to claim 19, wherein the system comprises a plurality of heat emission devices, which are of the same type, or a combination of different types.

21. The heating system according to claim 18, wherein the heating system comprises a controller for controlling the heating power delivered by the infrared lamp of the at least one fluid heating module.

22. The heating system of claim 21, wherein the controller comprises a thermostat and a separate solid state relay (SSR) for each fluid heating module, the solid state relay being coupled to the thermostat to receive an input signal therefrom and being coupled to the infrared lamp to control the voltage determined by the input signal to the infrared lamp.

23. The heating system of claim 22, wherein the controller further comprises a solid state relay (SSR) for the circulation pump.

24. The heating system according to claim 22, wherein the thermostat comprises a PI control.

25. (canceled)

26. (canceled)

27. (canceled)

28. A modular fluid heating and cooling device for a heating/cooling system having a fluid circuit, the fluid heating/cooling device comprising a supply conduit and a discharge conduit connectable to a return side and a feeding side of the fluid circuit of the heating/cooling system, and having at least one fluid heating module which can be connected to the discharge conduit and the supply conduit and at least one fluid cooling module which can be connected to the discharge conduit and the supply conduit,
wherein the fluid heating module comprises a substantially straight fluid tube having a threaded neck formed on each end thereof, a sleeve that is arranged concentrically within the fluid tube, which sleeve extends at least into the necks of the fluid tube, wherein in each neck a sealing ring is arranged between the neck and the sleeve, and a threaded ring is configured to cooperate with the thread of the neck, and which engages the sealing ring so as to seal the ends of the fluid tube, and wherein the fluid tube has, spaced apart from the respective necks, an inlet or and outlet, respectively, which can be coupled directly with the discharge conduit or supply conduit, respectively,
wherein the fluid heating module further comprises an infrared lamp having end consoles that rest on end portions of the sleeve, wherein electrical connection wires protrude from one or both end consoles so as to connect the infrared lamp to a power source,
wherein the fluid cooling module comprises a substantially straight fluid tube having a threaded neck formed on each end thereof, a sleeve that is arranged concentrically within the fluid tube, which sleeve extends at least into the necks of the fluid tube, wherein in each neck a sealing ring is arranged between the neck and the sleeve, and a threaded ring is configured to cooperate with the thread of the neck, and which engages the sealing ring so as to seal the ends of the fluid tube, and wherein the fluid tube has, spaced apart from the respective necks, an inlet or and outlet, respectively, which can be coupled directly with the discharge conduit or supply conduit, respectively,
wherein the fluid cooling module further has a gas connection at one end which is connected to the internal space of the sleeve and which is connectable to a cooling gas source, preferably a CO₂ gas source, and has a condensate discharge at an opposite end.

29. The modular fluid heating/cooling device according to claim 28, wherein a gas atomiser is arranged between the gas connection and the internal space of the sleeve to atomise the CO₂ gas and to form dry ice in said internal space of the sleeve.

30. The modular fluid heating/cooling device according to claim 28, wherein a reducing valve is arranged between the cooling gas source and the fluid cooling module.

31. A heating-cooling system having a fluid circuit and a circulation pump included in the fluid circuit, and further comprising a fluid heating/cooling device according to claim 28 that is included in the circuit, as well as at least one heat emission/heat absorption device in the circuit.

32. The heating system according to claim 31, wherein the at least one heat emission/heat absorption device is at least of the radiator, wall heating/cooling device, floor heating/cooling device or heat exchanger type.

33. The heating system according to claim 32, wherein the system comprises a plurality of heat emission/heat absorption devices, which are of the same type, or a combination of different types.
